(19) United States
(12) Patent Application Publication
(10) Pub. No.: US 2023/0374849 A1
(43) Pub. Date: Nov. 23, 2023

(54) Weatherstripping Backing with Self-Adjusting Angled Guideposts

(71) Applicant: Steve Abramson, Victor, NY (US)

(72) Inventor: Steve Abramson, Victor, NY (US)

(21) Appl. No.: 18/319,616

(22) Filed: May 18, 2023

Related U.S. Application Data
(60) Provisional application No. 63/364,930, filed on May 18, 2022.

(51) Int. Cl. E06B 7/23

(52) U.S. Cl. CPC E06B 7/2307

(57) ABSTRACT

A weatherstripping backing device is disclosed. The device includes an elongated backing strip comprising a first side and a second side. A pair of guide posts are located on the first side of the elongated flexible backing strip. The pair of guide posts are configured to receive at least a portion of a weatherstripping material therebetween. The pair of guide posts each include a first guide post portion extending between a first end coupled to the first side of the elongated backing strip and a second end. The first guide post portions of the pair of guide posts are separated from one another by a distance. A second guide post portion extends at an angle from the first guide post portion such that the distance between the pair of guide posts is decreased along a length of each of the of the second guide post portions

This application claims the benefit of U.S. Provisional Patent Application Ser. No. 63/364,930, filed May 18, 2022, which is hereby incorporated by reference in its entirety.

### FIELD

The present technology relates to a weatherstripping backing device. More specifically, the present technology relates to a weatherstripping backing device that provides an improved seal for resisting/reducing: drafts, air infiltration, sound infiltration, dust-dirt infiltration, germ-pollen infiltration, and bug infiltration.

### BACKGROUND

Weatherstripping is commonly used to seal windows, doors, and similar structures from air, moisture, sound, mold, dust, and pest infiltration. Weatherstripping creates a barrier that typically deforms sufficiently to allow the window or door to open and close properly but creates a somewhat impervious barrier. There are many types of weatherstripping on the market, including brass or metal strips, felt strips, blown rubber and extruded rubber strips, and brush or pile strips.

Brush weatherstripping is commonplace and relies on pile made of polypropylene or a similar fibrous material. Such weatherstripping often has a backing that can be inserted into a slot that traverses either the perimeter of the fenestration or the door or window placed in the fenestration. The slot may be in the form of a t-shaped channel that accommodates the backing of the weatherstripping. The weatherstripping backing is commonly pushed longitudinally into the channel where it is held in place.

FIG. 1 is an end view of a prior art weatherstripping device 101 in which the backing 103 includes pile fibers 109 extending from the backing 103. Traditional pile is made with fibers that sets or lays down very quickly after manufacturing, effectively losing the effectiveness of the seal in a short period of time. FIG. 2 illustrates a cross-sectional view of a typical installation of weatherstripping in an exemplary extruded frame 501. FIG. 2 depicts three weatherstripping devices 101 positioned within t-slots in the extruded frame 501. When installed, the pile fibers laying down causes the effectiveness of the seal to be decreased.

The present technology is directed to overcoming these and other deficiencies in the art.

### SUMMARY

One aspect of the present technology relates to a weatherstripping backing device. The device includes an elongated backing strip comprising a first side and a second side. A pair of guide posts are located on the first side of the elongated backing strip. The pair of guide posts are configured to receive at least a portion of a weatherstripping material therebetween. The pair of guide posts each include a first guide post portion extending between a first end coupled to the first side of the elongated backing strip and a second end. The first guide post portions of the pair of guide posts are separated from one another by a distance. A second guide post portion extends at an angle from the first guide post portion such that the distance between the pair of guide posts is decreased along a length of each of the of the second guide post portions.

Another aspect of the present technology relates to a weatherstripping backing device of the present technology having a weatherstripping material positioned between the pair of guide posts and extending in a substantially perpendicular direction from the first side of the elongated backing strip through the second guide post portions. The second guide post portions contact at least a portion of the weatherstripping material located between the pair of guideposts to support the weatherstripping material.

The present technology advantageously provides a weatherstripping backing device that is configured to hold up the weather sealing material inserted therein and push the weatherstripping material in the vertical direction. The weatherstripping backing device provides a long-term seal against the opposing sash of a moveable window or door. The weatherstripping backing material further provides an improved seal for resisting/reducing: drafts, air infiltration, sound infiltration, dust-dirt infiltration, germ-pollen infiltration, and bug infiltration.

### BRIEF DESCRIPTION OF THE DRAWINGS

FIG. 1 is an end view is an end view of a prior art weatherstripping device.

FIG. 2 is a cross-sectional view of a typical installation of the prior art weatherstripping device shown in FIG. 1 in an exemplary extruded frame.

FIG. 3 is an end view of an exemplary weatherstripping backing device in accordance with an aspect of the present technology.

FIG. 4 is an end view of the exemplary weatherstripping backing device having a pile fiber attached thereto in accordance with an aspect of the present technology.

FIG. 5 is an end view of the exemplary weatherstripping device with insulation fins according to another aspect of the present disclosure.

FIG. 6 illustrates another exemplary weatherstripping backing device in accordance with an aspect of the present technology.

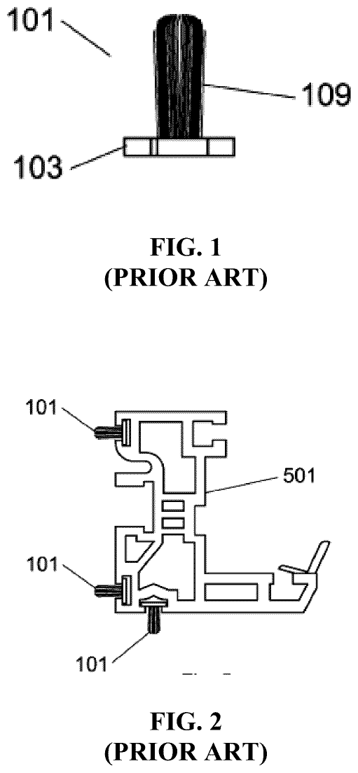

### DETAILED DESCRIPTION

The present technology relates to a weatherstripping backing device. More specifically, the present technology relates to a weatherstripping backing device that provides an improved seal for resisting/reducing: drafts, air infiltration, sound infiltration, dust-dirt infiltration, germ-pollen infiltration, and bug infiltration.

One aspect of the present technology relates to a weatherstripping backing device. The device includes an elongated backing strip comprising a first side and a second side. A pair of guide posts are located on the first side of the elongated backing strip. The pair of guide posts are configured to receive at least a portion of a weatherstripping material therebetween. The pair of guide posts each include a first guide post portion extending between a first end coupled to the first side of the elongated backing strip and a second end. The first guide post portions of the pair of guide posts are separated from one another by a distance. A second guide post portion extends at an angle from the first guide post portion such that the distance between the pair of guide posts is decreased along a length of each of the of the second guide post portions.

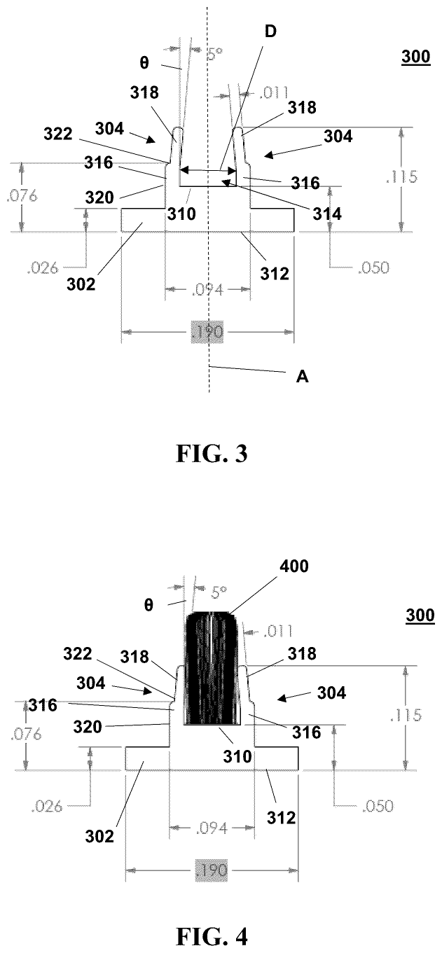

FIG. 3 illustrates an exemplary weatherstripping backing device 300 of the present technology. Although exemplary dimensions are illustrated in FIG. 3, it is to be understood that other configurations with other dimensions could be employed. Weatherstripping backing device 300 includes elongated backing strip 302 and guide posts 304, which each include first guide post portions 316 second guide post portions 318, although weatherstripping backing device 300 may include other types and/or numbers of elements in other configurations. In one example, weatherstripping backing device 300 may be extruded and formed in a unitary construction including each of the elements described herein, although other methods may be employed to form weatherstripping backing device 300.

Weatherstripping backing device 300 is advantageously configured to hold up the weather sealing material inserted therein and push the weatherstripping material in the vertical direction to provide an improved, longer lasting seal. The weatherstripping backing device also provides a seal against the opposing sash of a moveable window or door. Weatherstripping backing device 300 can be employed in a number of weatherstripping applications, for example, in fenestration products such as doors and windows for buildings, but could also be employed in other applications such as automotive doors, trunks, t-tops, convertible tops, and the like, boat components, or any other application where weatherstripping may be applied. For example, weatherstripping backing device 300 may be employed in an extruded frame for a window or door. Weatherstripping backing device 300 can advantageously be employed with any window or door system to provide improved sealing.

Weatherstripping backing device 300 can be made from plastic, although other suitable materials such as nylon or other synthetic materials may be employed. Suitable plastics include polypropylene, nylon, or other similar plastic materials. Weatherstripping backing device 300 can be formed, by way of example, using an extrusion process. In one example, the elements of weatherstripping backing device 300 are formed in a co-extrusion process to form different layers with varying properties, such as flexibility. In another example, the elements of weatherstripping backing device 300 can be formed as a dual durometer device. In another example, the weatherstripping backing device 300 is formed in a single extrusion with varying levels of softness, as described below.

Referring again to FIG. 3, elongated backing strip 302 is configured to be positioned, for example, in a t-slot of a window or door to provide weatherstripping along an edge of the door or window, as illustrated for example, in FIG. 2 (showing a prior art weatherstripping device inserted into a t-slot). Elongated backing strip 302 may have a suitable length to line an entire side of a window or door by way of example. In one example, elongated backing strip 302 can have widths in a range from 0.155 inches to 0.300 inches. In other examples, elongated backing strip 302 can have a width of about 0.155 inches, 0.187 inches, 0.190 inches, 0.229 inches, 0.250 inches, 0.270 inches, 0.300 inches. Although suitable lengths and widths are described, it is to be understood that the elongated backing strip 302 can have any dimensions configured to provide ease of manufacturing, as well as utilizing standard dimensions to allow convenient replacement of existing weatherstripping in a fenestration.

Elongated backing strip 302 includes first side 310 and second side 312. Second side 310 is configured to contact the inner portion of a t-slot in a door or window when installed. First side 310 is located opposite second side 312 and includes guide posts 304 located thereon. In one example, guide posts 304 are formed in a single extrusion along with elongated backing strip 302, although guide posts 304 can be coupled to elongated backing strip 302 in other manners. Although FIG. 3 shows an end view of weatherstripping backing device 300, it is to be understood that guide posts 304 extend along the length of elongated backing strip 302 and for channel 314 therebetween.

As described in further detail below, second side 312 has a weatherstripping material affixed thereto, such that a portion of the weatherstripping material is located in channel 314 between guide posts 304. Weatherstripping material extends beyond guide posts 304 to provide a weather barrier during use.

Guide posts 304 are located on first side 310 of elongated backing strip 302. Guide posts 304 each include first guide post portion 316 and second (angled) guide post portion 318. In one example, first guide post portions 316 extend in a direction perpendicular from elongated backing strip 302 between first end 320, which is coupled to first side 310 of elongated backing strip 302, to second end 322, although first guide post portions 316 may have other configurations. In this example, first guide post portions 316 are separated by a distance (D). First guide post portions 316 may have a varying thickness along their length. For example, first guide post portions 316 may be thicker near first end 320 and become thinner, i.e., more flexible toward second end 322.

Second guide post portions 318 extend at an angle (θ) from second ends 324 of first guide portions 316, respectively. Second guide post portions 318 extend toward central axis (A) of weatherstripping backing device 300 such that the distance between guide posts 304 is decreased along the length of each of second guide post portions 318, and may have varying lengths. In one example, each of the second guide post portions 318 extend toward the central axis (A) at the same angle (θ), although in other examples the second guide post portions 318 can extend toward central axis (A) at different angles. The angle (θ) can be between zero degrees to 85 degrees. In the example where the angle (θ) is equal to zero, the second guide post portions 318 provide a flexible extension of guide post 304 with an extended height.

Second guide post portions 318 have a thickness that may vary along the length of the second guide post portions 318. For example, second guide portions 318 may be thicker near their contact point with second end 322 of first guide post portions 316 and become thinner along their length. In one example, the thickness is at least about 0.12 inches at the thickest portion, although other thicknesses may be employed.

Second guide posts 318 are configured to be flexible, such that they can bend when pushed against an opposing surface opposite the elongated backing strip 302 when installed to provide an improved seal. Second guide posts 318 can range from a highly flexible to a more rigid (minimally flexible) material. For example, second guide posts 318 can contact an opposing sash (double hung, single hung, double slider or single slider moveable parts that either go up and down or side to side) of a moveable window or door. Second guide posts 318 can be formed with materials of varying flexibility (softness) as known in the art of extrusion of plastics.

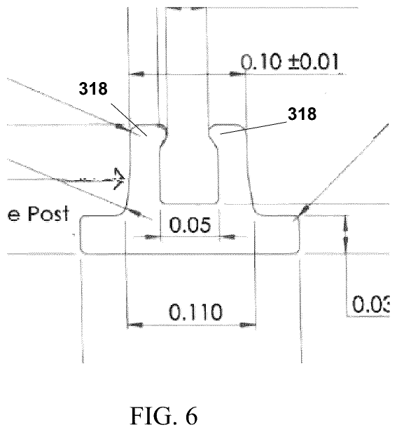

It is to be understood that other configurations could be employed for the second guide posts 318. For example, FIG. 6 illustrates an alternate configuration for the second guide posts 318.

Another aspect of the present technology relates to a weatherstripping backing device of the present technology having a weatherstripping material positioned between the pair of guide posts and extending in a substantially perpendicular direction from the first side of the elongated backing strip through the second guide post portions. The second guide post portions contact at least a portion of the weatherstripping material located between the pair of guideposts to support the weatherstripping material.

FIG. 4 illustrates weatherstripping backing device 300 having weatherstripping material 400 attached thereto. Weatherstripping material 400 can be pile fibers, needle punch, a plush material, closed cell foam, metal, vinyl, foam rubber, felt, silicone, polypropylene fins (soft or hard), and other natural and manmade materials. Although a number of exemplary weatherstripping materials are described, it is to be understood that any suitable weatherstripping can be used as weatherstripping material 400.

Weatherstripping material 400 is attached to elongated backing strip 302 between guide posts 304. In one example, weatherstripping material 400 is made of pile fibers constructed from polypropylene, polyester, nylon, vinyl, or other similar materials, although other weatherstripping materials may be employed. The weatherstripping material 400 can be needle punch, non-woven film material (e.g., quiet fin), film, spunbound, air-laid fiber, chemical bonded fiber, dry laid fiber, etc. The weatherstripping material 400 can be made of any material suited to make a seal against air drafts, water, sound, dust, etc. Pile fibers are commonly made as a yarn of synthetic material, but may also be made from natural materials such as plant and animal fibers, or other similar materials. Weatherstripping material 400 is attached to the elongated backing strip 302, by way of example, using adhesive bonding, ultrasonic welding, heat bonding, or mechanical bonding using a retaining structure affixed to or constructed as part of elongated backing strip 302. Such retaining structures may include, but are not limited to, longitudinal strips or a longitudinal channel, pressure fit slots, or other similar structures. Exemplary weatherstripping that may be employed in weatherstripping backing device 300 is disclosed in U.S. Pat. Nos. 3,175,256 and 3,690,038, the disclosures of which are incorporated herein by reference in their entirety.

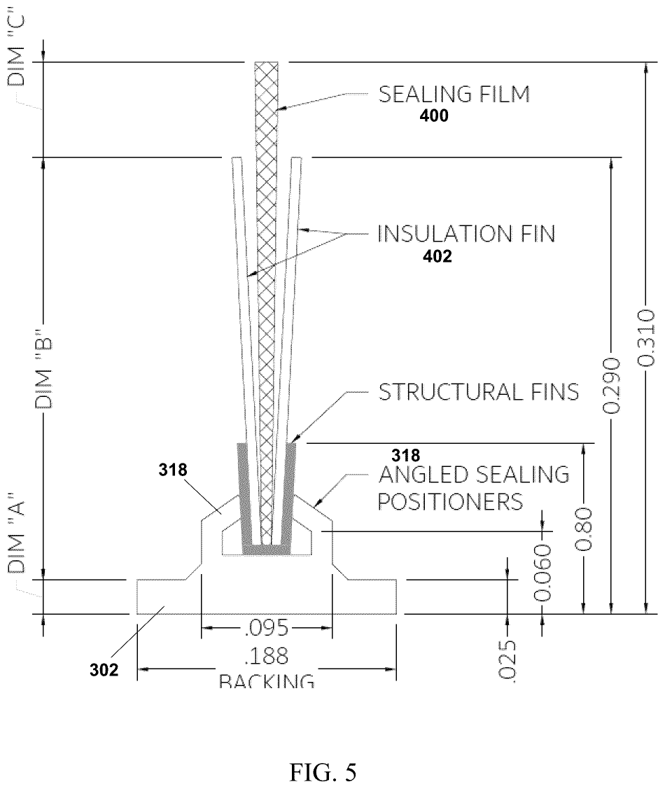

Referring again to FIG. 4, weatherstripping material 400 is positioned between guide posts 304 and extends in a substantially perpendicular direction from elongated backing strip 302 through second guide posts portions 318. In one example, the extruded elongated backing strip 302 the weatherstripping material 400 can include structural fins 402 as shown in FIG. 5, as part of the overall extrusion design. This allows the elongated backing strip 302 to incorporate the weatherstripping material 400 directly, as opposed to ultrasonically installing the weatherstripping material 400 to the elongated backing strip 302. Second guide post portions 318 contact the portion of the weatherstripping material 400 that passes therethrough and supports weatherstripping material 400. The angle of the second guide post portions 318 (which may be stiff or flexible) provide support to the weatherstripping material 400. In particular, the second guide post portions 318 push against opposing (left and right) sides of the weatherstripping material 400 to cause the weatherstripping material 400 to stand upright allowing for a longer term seal against the opposing surface of a window or door. Second guide post portions 318 center weatherstripping material 400 along central axis (A) and also bias weatherstripping material 400, such as pile fibers or needle punch, in the vertical direction along central axis (A) (perpendicular to elongated backing strip 302) to improve the effectiveness of the seal created by weatherstripping material 400 against the opposing surface of the sash or frame. Second guide post portions 318 keep the weatherstripping material 400 centered and upright to provide a longer term seal. Further, second guide post portions 318 are self-adjusting as they move with the window or door architecture to maintain the seal. The second guide portions 318 can be positioned such that they contact the weatherstripping material 400 at about half the height of the weatherstripping material 400 (as measured from the elongated backing strip 302), although other configurations may be employed. Thus, the second guide portions 318 provide support to other insulation material that is installed as the last placement phase of the sealing system. The final insulation can be welded between the second guide post portions 318 and the film support and seal. The insulation part can be clear film or a needle punch laminated to the film which would provide a filter product.

The contact of second guide post portions 318 to weatherstripping material 400 further provide a better range of compression and recovery of weatherstripping material 400 against the opposing surfaces of the sash or frame to provide a more long term seal. The improved seal resists/reduces drafts, air infiltration, sound infiltration, dust-dirt infiltration, germ-pollen infiltration, and bug infiltration. Second guide post portions 318 also contact the opposing surface of the sash or window when installed. The flexible second guide post portions 318 bend to provide additional contact with the opposing surface, providing a further improved seal. The combination of the force on weatherstripping material 400 in the vertical direction, as well as the contact of second guide post portions 318 to the opposing surface of the sash or frame creates an aggressive air block that reduces air leakage around the perimeter edges of the window or door.

Accordingly, this exemplary technology provides a number of advantages including providing a weatherstripping backing device that is configured to hold up the weather sealing material inserted therein and push the weatherstripping material in the vertical direction to provide improved sealing, as well as improved compression and recovery for the weatherstripping material. The weatherstripping backing device provides a long-term seal against the opposing sash of a moveable window or door. The weatherstripping backing material further provides improved seal resisting/reducing drafts, air infiltration, sound infiltration, dust-dirt infiltration, germ-pollen infiltration, and bug infiltration. The device can advantageously be employed in any window or door that uses a t-slot, curved slot, or any other slotted configuration used in vinyl, aluminum, wood, fiberglass, etc. windows and doors.

Having thus described the basic concept of the disclosed technology, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the disclosed technology. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A weatherstripping backing device comprising:
an elongated backing strip comprising a first side and a second side;
a pair of guide posts located on the first side of the elongated backing strip, the pair of guide posts configured to receive at least a portion of a weatherstripping material therebetween, the pair of guide posts each comprising:
a first guide post portion extending between a first end coupled to the first side of the elongated backing strip and a second end wherein the first guide post portions of the pair of guide posts are separated from one another by a distance; and
a second guide post portion extending at an angle from the first guide post portion such that the distance between the pair of guide posts is decreased along a length of each of the of the second guide post portions.

2. The weatherstripping backing device of claim 1, wherein the second guide post portions on the pair of guide posts extend at different angles.

3. The weatherstripping backing device of claim 1, wherein the second guide post portion of each of the pair of guideposts is flexible.

4. The weatherstripping backing device of claim 3, wherein the second guide post portion of each of the pair guideposts has a varying flexibility along the length thereof.

5. The weatherstripping backing device of claim 1, wherein the second guide post portion of each of the pair of guideposts is configured to contact at least a portion of the weatherstripping material located between the pair of guideposts to support the weatherstripping material.

6. The weatherstripping backing device of claim 5, wherein the second guide post portion of each of the pair of guideposts is configured to bias the weatherstripping material in a direction substantially perpendicular to the elongated backing strip.

7. The weatherstripping backing device of claim 5, wherein the second guide post portions of each of the pair of guideposts have varying lengths.

8. The weatherstripping backing device of claim 1, wherein the second guide post portions are formed from two different co-extruded materials.

9. The weatherstripping backing device of claim 1, wherein the second guide post portions are formed from a dual durometer material.

10. The weatherstripping backing device of claim 1, wherein the elongated backing strip is configured to be located in a t-slot in an extruded frame.

11. A weatherstripping device comprising:
a weatherstripping backing device comprising:
an elongated backing strip comprising a first side and a second side;
a pair of guide posts located on the first side of the elongated backing strip, the pair of guide posts each comprising:
a first guide post portion extending between a first end coupled to the first side of the elongated backing strip and a second end wherein the first guide post portions of the pair of guide posts are separated from one another by a distance; and
a second guide post portion extending at an angle from the first guide post portion such that the distance between the pair of guide posts is decreased along a length of each of the of the second guide post portions;
a weatherstripping material positioned between the pair of guide posts and extending in a substantially perpendicular direction from the first side of the elongated backing strip through the second guide post portions, wherein the second guide post portions contact at least a portion of the weatherstripping material located between the pair of guideposts to support the weatherstripping material.

12. The weatherstripping device of claim 11, wherein the second guide post portions on the pair of guide posts extend at different angles.

13. The weatherstripping device of claim 11, wherein the second guide post portion of each of the pair of guideposts is flexible.

14. The weatherstripping device of claim 13, wherein the second guide post portion of each of the pair guideposts has a varying flexibility along the length thereof.

15. The weatherstripping device of claim 11, wherein the second guide post portion of each of the pair of guideposts is configured to bias the weatherstripping material in a direction substantially perpendicular to the elongated backing strip.

16. The weatherstripping device of claim 11, wherein the second guide post portions of each of the pair of guideposts have varying lengths.

17. The weatherstripping device of claim 11, wherein the second guide post portions are formed from two different co-extruded materials.

18. The weatherstripping device of claim 11, wherein the second guide post portions are formed from a dual durometer material.

19. The weatherstripping device of claim 11, wherein the elongated backing strip is configured to be located in a t-slot in an extruded frame.

20. The weatherstripping device of claim 11, wherein the weatherstripping material comprises pile fibers or needle punch.
